(19) United States
(12) Patent Application Publication
(10) Pub. No.: US 2015/0086679 A1
(43) Pub. Date: Mar. 26, 2015

(54) HIGH MEAT PET FOOD TREATS

(71) Applicant: Normerica Inc., Port Credit (CA)

(72) Inventor: Kari Seguin, Dundas (CA)

(21) Appl. No.: 14/492,260

(22) Filed: Sep. 22, 2014

Related U.S. Application Data
(60) Provisional application No. 61/881,306, filed on Sep. 23, 2013.

(51) Int. Cl. A23K 1/10; A23K 1/16; A23K 1/00

(52) U.S. Cl. CPC A23K 1/10; A23K 1/003; A23K 1/16
USPC 426/104; 426/574; 426/513

(57) ABSTRACT

Described herein is a pet food composition comprising between 55 and 90% by weight raw ground meat, between 1 and 45% absorbent fiber, between 1 and 25% hydrocolloid, between 0.1 and 25% humectant; and a flavouring agent, wherein the composition comprises between 25 and 45% by weight water, and the composition is suitable for rotary molding. The composition can be used to make high meat inclusion pet treats that do not contain flour, and that can be made by rotary molding.

### CROSS REFERENCE TO RELATED APPLICATIONS

The present application claims benefit under 35 U.S.C. 119(e) to U.S. Provisional Patent Application Ser. No. 61/881,306, filed Sep. 23, 2013, the contents of which are hereby incorporated by reference.

### FIELD

The invention relates to a pet treat that includes a high percentage of chicken and no flour, and that is formed by rotary molding.

### BACKGROUND

Meat treats for pets are well-known pet food items. Pet dry meat treats such as “jerky” are chewy, have low to intermediate moisture and are relatively dense compared to conventional dry pet treats or semi-moist pet treats. These products have good shelf stability because of their low water content, they generally have a high meat content (i.e., 60 to 80%), and they have a texture that is soft and pliable, yet the product is cohesive.

There are two commonly employed methods for making pet foods, rotary molding and extrusion. In rotary molding, dough may be top-loaded into a negative impression die, released from the die and then oven baked. In extrusion, dough is pushed or drawn through a die where it may be cut to the desired length and then baked. Alternatively, the dough may be cooked as it passes through the extruder, and cut into appropriate sizes upon exiting the extruder (cooker extrusion).

Pet treats that include a high proportion of meat (40 wt % or less) are typically made by cooker extrusion, and cold extrusion is used for high meat inclusion treats that contain about 55 wt % or less meat, because when the meat reaches high proportions in the dough mixture, the moisture content of the dough is too high and the texture is too fluid or loose to allow for rotary molding.

U.S. Pat. No. 5,026,572 to Neiberger discloses a high meat inclusion jerky-type product that is made by multiple extrusion steps and which contains flour. U.S. Pat. No. 5,045,339 to Ducharme discloses a high meat content (40 to 55 wt %) jerky-type pet treat that is made by a multi-step extrusion cooking process. U.S. Pat. No. 6,238,726 to Fisher et al. describes a high meat-containing snack that is made by feeding ground meat and a mixture of dry ingredients, in independent streams, into an extrusion cooker. U.S. Pat. No. 6,410,079 to Cheuk et al. discloses a composition comprising about 40 wt % meat and a cellulosic material in quantities effective to allow extrusion, that is made by extrusion. US 2012/0237642 to Gardewin discloses a semi-moist, cereal-free, animal food product that has a very high meat content (>80 wt %), and that is made by extrusion cooking.

In U.S. Pat. No. 5,731,029 to Karwowski et al., jerky products having a high proportion of meat are produced from meat that is substantially frozen, and which is comminuted and then heated to at least partially denature the protein of the meat. This meat is then cooled to solidify the fat, and mixed with a binding agent and other ingredients before it can be further processed by rotary molding.

One way to make dough that is suitable for rotary molding is to add flour. U.S. Pat. No. 8,309,157 to Lombard et al. describes a strip-shaped pet treat that comprises a high proportion of meat and significant amount of flour, and that is made by rotary molding. The flour is said to unexpectedly increase the strength and flexibility of the strip-shaped product. The meat is cooked before it is mixed with the flour. However, there is a need for pet treat products that do not contain flour.

US 2012/0082762 to Weinberg et al. discloses pet treats that comprise more than 50 wt % meat that is not extruded, ground, emulsified, liquefied, partially liquefied or made into a powder. In order to reduce the moisture content of the meat, the meat alone, or in combination with other ingredients, is dried for extensive periods of time at ≦85° C.

There is a continuing need for new and useful pet treat products of good quality, and methods of making these products. Described herein is a composition for, and a method of, making a high inclusion meat pet treat that does not contain flour, and that is made by rotary molding.

### SUMMARY

The rotary molding process described herein begins with a raw meat that has high moisture content, for example of about 70 to 80 wt %. This raw meat product is mixed with an absorbent fiber that binds to the water and reduces the % moisture by weight to about 30 to 40%, which is suitable for rotary molding. To the mixed product may be added minor amounts of gelatin, hydrocolloid, humectants and flavourings.

The pieces formed by rotary molding of the dough are baked and dried, to obtain shelf stable products that are robust and flexible, without breaking, and which exhibit the texture and appearance of jerky or other chewable pet treat.

In one aspect the invention is a pet food composition comprising:

(a) between 55 and 90% by weight raw ground meat;

(b) between 1 and 45% absorbent fiber;

(c) between 1 and 25% hydrocolloid;

(d) between 0.1 and 25% humectant; and

(e) a flavouring agent,

wherein the composition comprises between 25 and 45% by weight water, and wherein the composition is suitable for rotary molding.

In one embodiment the composition comprises between 30 and 40% by weight water. In another embodiment the composition comprises between 28 and 34% by weight water.

In one embodiment the composition comprises between 65 to 75% by weight raw ground meat. In another embodiment the composition comprises between 70 and 75% by weight raw ground meat.

In one embodiment the composition comprises between 10 and 20% by weight absorbent fiber. In another embodiment the composition comprises between 10 and 15% by weight absorbent fiber.

In one embodiment the composition comprises between 1 and 15% by weight hydrocolloid. In another embodiment the composition comprises between 1 and 10% by weight hydrocolloid.

In one embodiment the composition comprises between 0.1 and 10% by weight humectant. In another embodiment the composition comprises between 0.1 and 2% by weight humectant.

In a particularly preferred embodiment the raw ground meat is chicken.

In another aspect the invention is a method for the production of meat-based pet treat products comprising the steps of:
(a) preparing a composition as described above;
(b) forming the composition into pieces by rotary molding;
(c) reducing the moisture content of said pieces to less than or equal to about 30% by weight.

In one embodiment, the moisture content of the pieces is reduced by baking in an oven for less than 60 minutes. In another embodiment, the moisture content of the pieces is reduced by baking in an oven for about 30 minutes.

In a further embodiment, the moisture content of the pieces is further reduced by drying for less than 15 minutes.

In one embodiment, baking is performed at a temperature of between 380° F. and 550° F. In another embodiment, the baking is performed at a temperature of between 380° F. and 500° F.

In one embodiment, the drying is performed at a temperature of more than 100° F. In another embodiment the drying is performed at a temperature of between 120 and 130° F.

In another aspect, the invention is a meat-based pet treat product produced by any one of the methods described above.

### DETAILED DESCRIPTION

Described herein is a product that is a shelf stable, high meat inclusion pet treat that is rotary molded and oven baked. The homogeneous dough is comprised of primarily ground raw meat, followed by an absorbent fiber, and minor inclusions of gelatin, a hydrocolloid, a flavouring agent and a humectant. Because of the inclusion of high amounts of a high moisture meat (70 to 80 wt % moisture), the meat is mixed with an absorbent fiber to dry the dough mixture and provide a dough that has the moisture content required for rotary molding (30 to 40 wt % moisture). The absorbent fiber binds with the water and the fat components of the ground meat.

The composition described herein has a moisture and consistency compatible with being rotary molded into individual treat pieces that can then be further processed through a continuously fed oven and cooler drying, to a finished product having a moisture content of 4 to 30 wt %. The dough mixture and texture are set in a unique way as to be dried and gelatinized preferably within a maximum of 30 minutes in an oven that has a temperature of between 450 to 520° F., followed by a maximum of 15 minutes of drying (or dwell time) and cooling time.

Typically, pet biscuit dough mixtures for rotary molding have a moisture content in the range of 30 to 40 wt % and are oven baked within a typical range of 30 minutes down to a moisture content of 10 to 12 wt %, for a typical moisture loss of 25 wt %. The composition and method herein describe a process wherein a high inclusion raw meat product can be formed into pet treats by rotary molding, because the composition includes an absorbent fiber that binds to water (and fat) and reduces the active water content of the composition to between 25 to 45 wt %, preferably 30 to 40 wt % which is suitable for rotary molding. Notably, this is achieved without the addition of flour to the composition.

The present composition and method provides treats for pets, such as dogs and cats. It is made with raw meat. Raw meat has a high moisture content and a high fat content, typically about 70 to 80% by weight moisture. The use of significant amounts of raw meat in a pet treat provides a denser or more compact chewy texture and a strong meat flavour. However, the use of significant amounts of raw meat in dough that is destined for rotary molding presents several problems, because of the high moisture content of the meat. This high moisture content can adversely affect dough machinability in terms of stickiness, excessive softness or loss of viscosity. For rotary molding the dough must have a texture or consistency that is pliable but not so sticky that it will not come out of the rotary molder die, and not so greasy, wet or loose that it will not stay in the mold to get formed. The molded treats must also retain their shape as they pass through the oven at high temperatures; the treats cannot melt and bleed into the open steel mesh of the oven belt that holds the product as it passes through the oven. In addition, excessively high moisture contents in the dough would require prolonged baking and drying times to achieve a particular final moisture content

Accordingly, if it is desirable to prepare a pet treat that has a high proportion of raw meat by rotary molding, the moisture content and texture of the dough must be suitable for rotary molding. Taking into account all of the sources of water in the dough, including separately added water, the total initial water content of the dough is generally at least about 25% by weight to about 45% by weight. A preferred range of water in various embodiments is between 30 and 40% by weight, more preferably 28 and 34% by weight, and most preferably between 30 and 32% by weight.

Raw meat, as used herein, refers to non-rendered and non-dried fresh, frozen, or a mixture of fresh and frozen meat that has been ground. It also refers to mechanically separated meat that has been ground. In using ground raw meats, the inner cellular components of the meat, such as proteins, are released into the composition, where they are able to bind to free water and thereby assist in decreasing the amount of active water in the composition. Raw meat includes raw meat products and raw meat by-products, and mixtures thereof. Many types of raw flesh, or mixtures of raw flesh, may be included in the term raw meat as used herein, such as chicken, turkey, duck, goose, lamb, beef, horse, fish and flesh from other animals. Chicken is the preferred raw meat, and preferably no meat by-products are added to the ground meat product

The moisture content of raw meat is generally at least about 70% by weight, and most often between 75 to 80% by weight, based on the weight of the raw meat.

The amount of raw meat used in the compositions can range from 55 to 90% by weight of the rotary moldable dough. In various embodiments, the amount of raw meat used may be at least about 55% by weight, more preferably at least about 65% by weight and most preferably at least about 70% by weight. Preferably the range of raw meat used in the compositions can be between 55 to 80% by weight, more preferably between 55 and 75% by weight, more preferably between 65 and 75% by weight, and most preferably between 70 and 75% by weight of the rotary moldable dough.

In the methods described herein raw meat is preferably used in a cold but not frozen form. Ice crystals in the meat interfere with the rotary molding process because water in the ice form cannot be absorbed by the fiber and other dry ingredients. Further, ice acts as a barrier, interfering with the ability of the dough to manipulated into a homogeneous mixture, which results in a brittle product that will break apart.

The dough compositions described herein may include an absorbent fiber. An absorbent fiber as used herein refers to a fiber that binds to and absorbs water and fat from the chicken to form dough having the texture needed for rotary molding. These compounds are also known as dough texture cohesives, or viscose agents. Useful absorbent fibers include oat fiber, rye fiber, barley fiber, carboxymethyl cellulose and cellulose. Exemplary useful absorbent fibers are VITACEL® HF401 oat fiber obtained from J. Rettenmaier USA LP and whole grain (brown) rice flour obtained from Normerica Northdown. The amount of absorbent fiber can range between 1 and 45% by weight of the rotary moldable dough. In various embodiments, the amount of absorbent fiber used may be at least about 1% by weight, more preferably at least about 5% by weight and most preferably at least about 13% by weight. A preferred range of absorbent fiber in various embodiments is between 10 and 45% by weight, more preferably between 10 and 30% by weight, more preferably between 10 and 20% by weight, and most preferably between 10 and 15% by weight of the dough composition.

The dough compositions described herein may include a hydrocolloid. “Hydrocolloid” as used herein refers to a compound that forms a gel with water and that crosslinks upon drying to provide a rigid texture for the pet treat. Hydrocolloids are compounds which can absorb between about one to 20 times their weight in water. Useful hydrocolloids include cassia gum, xantham gum, guar gum, locust bean gum, carrageenan gum, starches, alginin, collagen, agar, polysaccharides, pectin and gelatin. Gelatin is well-known in the art as a gelling agent derived from collagen obtained from various animal by-products. It is used in the composition to bind the edible components together so that they can be readily processed and formed into the pet treat. The amount of hydrocolloid used in the compositions can range from 1 to 25% by weight of the rotary moldable dough. In various embodiments, the amount of hydrocolloid used may be less than 25% by weight, more preferably less than about 10% by weight and most preferably less than about 5% by weight. A preferred range of hydrocolloid in various embodiments is between 1 and 25% by weight, more preferably between 1 and 15% by weight, and most preferably between 1 and 10% by weight.

The dough compositions described herein may include a humectant. “Humectant” as used here refers to a compound that is hygroscopic and thus that is used to slow down the tendency of such a product to dry out and to thereby maintain the pliability of the pet treat, keeping it moist and soft to provide a chewy product. Humectants may also enhance palatability. Useful humectants include molasses, high fructose syrup, liquid sugars and sugar alcohols. The amount of humectants used in the compositions can range from 0.1 to 25% by weight of the rotary moldable dough. In various embodiments, the amount of humectant used may be at least about 0.1% by weight, more preferably at least about 0.5% by weight and most preferably at least about 1% by weight. A preferred range of humectant in various embodiments is between 0.1 and 15% by weight, more preferably between 0.1 and 10% by weight, and most preferably between 0.1 and 2% by weight.

The dough compositions described herein may include a flavouring agent. “Flavouring agent” as used herein is a compound that enhances the palatability of the pet treat. A useful flavouring agent is Brewer's yeast. Other useful flavouring agents include spices such as garlic, cloves or onion, cheese or cheese powder, eggs, bacon or bacon powder or flavouring, fish, poultry or liquid smoke flavouring, and sweet potato (dry, fresh or frozen). Preferred flavours for the compositions include organic chicken, duck, salmon and turkey and sweet potato flavours.

The compositions may additionally comprise other ingredients that are conventionally found in pet treat products, in conventional amounts, such as preservatives and curing agents, antioxidants, additional fats or oils, colouring agents, filler and anticaking agents.

The amount of absorbent fiber used in making up the meat-based rotary moldable dough will depend upon a number of factors. The factors include but are not limited to the amount and type of raw meat used and the amounts of other ingredients in the dough. The amount of fiber used should be sufficient to bind water in the meat and any added water, so as to provide, along with the other dough ingredients, a cohesive, rotary-moldable meat-based dough. Generally, the higher the moisture content of a given meat or dough, the higher should be the amount of absorbent fiber.

Further described herein is a method of making a high meat inclusion pet treat. The raw meat, which is preferably provided by the supplier as a ground meat, may first be blended in a mixer, for example, a sigma blade-style mixer or a ribbon blender mixer. A suitable mixing time is about one minute or less on a slow speed setting. Other types of industrial mixers, known to those of skill in the art, may be used.

The dry ingredients, except for the absorbent fiber, may then be added to the mixed meat, and this mixture is again mixed together. A suitable mixing time is about one minute or less on a slow speed setting.

The absorbent fiber may then added and the mixture again mixed together. A suitable mixing time is about five minutes or less on a high speed setting, with the objective being to avoid overworking of the product.

Although the ingredients are described above as being added in a particular order, the order in which the materials are added to the mixer and mixed together is not crucial. All mixing is performed at ambient temperature but it could as well be performed at refrigerated temperatures, i.e., about 4° C.

The dough thus produced is then formed into treat sized pieces by rotary molding, at ambient temperature. The dough may be transferred from the mixer and into the rotary molder dough hopper on an incline conveyor.

On exiting the dough hopper, the dough is formed into pieces by rotary molding. This is accomplished by passing the dough into the rotary molder, and then through two counter-rotating drums, a rotating feeding drum and a rotary molding drum or die roll, which are adjacent to and in contact with one another. The rotary molding drum is provided with a plurality of molding cavities positioned about the peripheral surface of the drum. As the dough passes between the rotary molding drum and rotating feeding drum, it is pressed into the molding cavities. A wiper or scraper blade is used to remove any excess dough material that extends above the molding cavities. Positioned under the rotary molding drum is a pressing drum or forming roll, which may comprise around its periphery a cotton (or other material) conveyor belt to which the individual dough pieces that are formed will preferentially adhere, as compared to the inner surfaces of the molding cavities. The individual dough pieces therefore effectively adhere to the cotton conveyor belt and are released from the molding cavities. They are then transferred in a monolayer towards the oven for baking.

The rotary molded pieces may be produced in a variety of shapes such as bone shaped, chop shaped, nugget shaped, strip shaped, round, triangular, square, and the like, and may be embossed, for example with letters or symbols. The dies used have dimensions that will provide a product that can be dried down and thermally processed in less than about 60 minutes, preferably less than about 45 minutes.

On the way to the oven the dough pieces are transferred from the cotton conveyor belt to a conveyor belt that is to be used in the oven, such as an open mesh belt like an open mesh steel belt. The moisture content of the dough pieces on entering the oven may be the same as the moisture content of the dough. The pieces are baked at an oven temperature that will achieve an internal temperature of at least 90° C. for export purposes and to achieve a proper kill step to reduce food spoilage (increase shelf life).

The baking and drying are used to reduce the moisture content of the product. Preferably both an oven and a dryer are used in the method. The moisture reduction is conducted at temperatures that do not cause the pieces to shrivel or otherwise become deformed. The final product after baking and drying has a moisture content of less than about 30 wt % water and more than about 4 wt % water, based on the weight of the final product. Preferably the water content is less than 20 wt %, and even more preferably less than 15 wt %. In a most preferred embodiment the final product has a final moisture content of 10 to 12%.

Generally, the combined time for baking and drying, to reduce the moisture content of the rotary molded pieces, is less than about 60 minutes, and preferably less than about 45 minutes. An exemplary baking time is 30 minutes, which may be divided into 10 minute increments, with different exposure temperatures at each increment. An exemplary drying time is 15 minutes or less. However, longer or shorter baking and drying times may be used.

Generally the baking temperatures are at least about 350° F., and preferably range from about 380 to 550° F., more preferably from about 380 to 500° F. Conventional baking ovens may be used for baking the rotary molded pieces. Multi-zoned ovens are preferred.

Drying may be performed in a conventional dryer such as a continuous belt dryer or oven. The moisture content of the baked pieces exiting the oven may be further reduced in the dryer to their final moisture content. The pieces are dried sufficiently to obtain a shelf-stable product without adversely affecting flexibility, texture or palatability.

Generally, the drying temperatures are at least about 100° F., and preferably in the range of from about 110° F. to 140° F., more preferably about 120° F. to 130° F.

After drying the product is transported to a packing operation and packaged in moisture proof bags.

The final products have a water activity of less than about 0.65 to ensure that the product will have an acceptable shelf life.

### EXAMPLES

The following are representative examples of the composition and method.

### Example 1

The following ingredients were mixed together:

| | Amount (kg) | wt. % |
|---|---|---|
| MSM Fresh Chicken | 219 | 73 |
| Oat Fiber (Vitacel ®) | 39 | 13 |
| Cassia Gum | 16.5 | 5.5 |
| Brewer's Yeast | 12 | 4 |
| Pork Skin Gelatin | 7.5 | 2.5 |
| Molasses | 6 | 2 |

The chicken was blended in a sigma blade-style mixer for 30 seconds on slow speed and for one minute on fast speed. The dry ingredients, except for the oat fiber, were added to the chicken and this mixture was blended for 30 seconds on slow speed and for one minute on fast speed. The oat fiber was added, and the mixture was blended for five minutes on fast speed.

To make chicken nuggets, the following conditions were used:

### Oven Settings:

### Zone 1: 420° F.

### Zone 2: 420° F.

### Zone 3: 380° F.

### Dryer Temperature: 130° F.

Oven time: 40 Hertz (30 minutes)

### Die Speed: 5.34 RPM

### Feed Roll: 401 RPM

The product is pressed into the die, removed from the die and then placed in each zone of the oven for 10 minutes. The internal temperature of the product must be a minimum of 90° C. The product is then placed into the dryer for 13 minutes to achieve a moisture content of less than 12%.

To make chicken fingers, the following conditions were used:

### Oven Settings:

### Zone 1: 480° F.

### Zone 2: 490° F.

### Zone 3: 420° F.

### Dryer Temperature: 120° F.

Oven time: 36 Hertz (27 minutes)

### Die Speed: 9.22 RPM

### Feed Roll: 7.84 RPM

The product is pressed into the die, removed from the die and then placed in each zone of the oven for 10 minutes. The internal temperature of the product must be a minimum of 90° C. The product is then placed into the dryer for 13 minutes to achieve a moisture content of less than 12%.

### Example 2

The following ingredients were mixed together:

| | Amount (kg) | wt. % |
|---|---|---|
| MSM Fresh Chicken | 219 | 73 |
| Oat Fiber (Vitacel ®) | 39 | 13 |
| Cassia Gum | 15 | 5 |
| Brewer's Yeast | 9 | 3 |
| Pork Skin Gelatin | 15 | 5 |
| Molasses | 3 | 1 |

The chicken was blended in a sigma blade-style mixer for 30 seconds on slow speed and for one minute on fast speed. The dry ingredients, except for the oat fiber, were added to the chicken and this mixture was blended for 30 seconds on slow speed and for one minute on fast speed. The oat fiber was added, and the mixture was blended for five minutes on fast speed.

To make chicken nuggets the following conditions were used:

### Oven Settings:

### Zone 1: 520° F.

### Zone 2: 520° F.

### Zone 3: 450° F.

### Dryer Temperature: 130° F.

Oven time: 40 Hertz (30 minutes)

### Die Speed: 5.34 RPM

### Feed Roll: 401 RPM

The product is pressed into the die removed from the die and then placed in each zone of the oven for 10 minutes. The internal temperature of the product must be a minimum of 90° C. The product is then placed into the dryer for 13 minutes to achieve a moisture content of less than 12%.

To make chicken fingers, the following conditions were used:

### Oven Settings:

### Zone 1: 480° F.

### Zone 2: 490° F.

### Zone 3: 420° F.

### Dryer Temperature: 120° F.

Oven time: 36 Hertz (27 minutes)

### Die Speed: 9.22 RPM

### Feed Roll: 7.84 RPM

The product is pressed into the die, removed from the die and then placed in each zone of the oven for 10 minutes. The internal temperature of the product must be a minimum of 90° C. The product is then placed into the dryer for 13 minutes to achieve a moisture content of less than 12%.

### Example 3

The following ingredients were mixed together:

| | Amount (kg) | wt. % |
|---|---|---|
| MSM Fresh Chicken | 210 | 70 |
| Oat Fiber (Vitacel ®) | 48 | 16 |
| Cassia Gum | 16.5 | 5.5 |
| Brewer's Yeast | 12 | 4 |
| Pork Skin Gelatin | 7.5 | 2.5 |
| Molasses | 6 | 2 |

The chicken was blended in a sigma blade-style mixer for 30 seconds on slow speed and for one minute on fast speed. The dry ingredients, except for the oat fiber, were added to the chicken and this mixture was blended for 30 seconds on slow speed and for one minute on fast speed. The oat fiber was added, and the mixture was blended for five minutes on fast speed.

The conditions noted above were used to make chicken nuggets or chicken fingers.

### Example 4

The following ingredients were mixed together:

| | Amount (kg) | wt. % |
|---|---|---|
| MSM Fresh Chicken | 217 | 72.25 |
| Oat Fiber (Vitacel ®) | 39 | 13 |
| Cassia Gum | 15 | 5 |
| Brewer's Yeast | 9 | 3 |
| Pork Skin Gelatin | 15 | 5 |
| Molasses | 5 | 1.75 |

The chicken was blended in a sigma blade-style mixer for 30 seconds on slow speed and for one minute on fast speed. The dry ingredients, except for the oat fiber, were added to the chicken and this mixture was blended for 30 seconds on slow speed and for one minute on fast speed. The oat fiber was added, and the mixture was blended for five minutes on fast speed.

The conditions noted above were used to make chicken nuggets or chicken fingers.

While the method and composition have been described in conjunction with the disclosed embodiments and example, it will be understood that the invention is not intended to be limited to these embodiments and examples, but rather to cover alternatives, modifications, and equivalents, which may be included within the spirit and scope of the embodiments and examples as described herein.

We claim:

1. A pet food composition comprising:
(a) between 55 and 90% by weight raw ground meat;
(b) between 1 and 45% absorbent fiber;
(c) between 1 and 25% hydrocolloid;
(d) between 0.1 and 25% humectant; and
(e) a flavouring agent,
wherein the composition comprises between 25 and 45% by weight water, and
wherein the composition is suitable for rotary molding.

2. The composition of claim 1 comprising between 30 and 40% by weight water.

3. The composition of claim 1 comprising between 28 and 34% by weight water.

4. The composition of claim 1, comprising between 65 to 75% by weight raw ground meat.

5. The composition of claim 1, comprising between 70 and 75% by weight raw ground meat.

6. The composition of claim 1, comprising between 10 and 20% by weight absorbent fiber.

7. The composition of claim 1, comprising between 10 and 15% by weight absorbent fiber.

8. The composition of claim 1, comprising between 1 and 15% by weight hydrocolloid.

9. The composition of claim 1, comprising between 1 and 10% by weight hydrocolloid.

10. The composition of claim 1, comprising between 0.1 and 10% by weight humectant.

11. The composition of claim 1, comprising between 0.1 and 2% by weight humectant.

12. The composition of claim 1, wherein the raw ground meat is chicken.

13. A method for the production of meat-based pet treat products comprising the steps of:
(a) preparing a composition according to claim 1;
(b) forming the composition into pieces by rotary molding;
(c) reducing the moisture content of said pieces to less than or equal to about 30% by weight.

14. The method of claim 13 wherein the moisture content of the pieces is reduced by baking in an oven for less than 60 minutes.

15. The method of claim 13, wherein the moisture content of the pieces is reduced by baking in an oven for about 30 minutes.

16. The method of claim 14, wherein the moisture content of the pieces is further reduced by drying for less than 15 minutes.

17. The method of claim 14 wherein the baking is performed at a temperature of between 380° F. and 550° F.

18. The method of claim 14 wherein the baking is performed at a temperature of between 380° F. and 500° F.

19. The method of claim 16, wherein the drying is performed at a temperature of more than 100° F.

20. The method of claim 16, wherein the drying is performed at a temperature of between 120 and 130° F.

21. A meat-based pet treat product produced by the method of claim 13.
